(19) United States
(12) Patent Application Publication
(10) Pub. No.: US 2016/0371600 A1
(43) Pub. Date: Dec. 22, 2016

(54) SYSTEMS AND METHODS FOR VERIFICATION AND ANOMALY DETECTION USING A MIXTURE OF HIDDEN MARKOV MODELS

(71) Applicant: GE Aviation Systems LLC, Grand Rapids, MI (US)

(72) Inventors: Johan Fredrik Markus Svensen, Southampton (GB); David Stephen Hardwick, Fareham (GB); Honor Elisabeth Georgette Powrie, Southampton (GB)

(21) Appl. No.: 15/181,876

(22) Filed: Jun. 14, 2016

(30) Foreign Application Priority Data
Jun. 22, 2015 (GB) 1510957.2

(51) Int. Cl. G06N 7/00; E21B 33/06; E21B 47/00; G06N 99/00

(52) U.S. Cl. CPC G06N 7/005; G06N 99/005; E21B 33/06; E21B 47/00

(57) ABSTRACT

The present disclosure relates to systems and methods for monitoring data recorded from systems over time. The techniques described herein include the ability to detect and classify system events, and to provide indicators of normal system operation and anomaly detection. The systems and methods of the present disclosure can represent events occurring in the system being monitored in such a way that the temporal characteristics of the events can be captured and utilized for detection, classification and/or anomaly detection, which can be particularly useful when dealing with complex systems and/or events.

### PRIORITY CLAIM AND INCORPORATION BY REFERENCE

The present application claims priority to and the benefit of Great Britain Patent Application Number 1510957.2, filed Jun. 22, 2015, titled “Systems and Methods for Verification and Anomaly Detection.” Great Britain Patent Application Number 1510957.2 is hereby incorporated by reference in its entirety.

### FIELD OF THE INVENTION

The present subject matter relates generally to systems and methods for condition monitoring and, more particularly, systems and methods for verification and anomaly detection using a Mixture of Hidden Markov Models.

### BACKGROUND OF THE INVENTION

Many systems can benefit from condition monitoring in which the operational status of one or more system components and/or the system as a whole can be actively monitored. In particular, condition monitoring can include verification of the proper operation of the component(s) or system and/or detection of anomalous operation of the component(s) or system.

Example systems that can benefit from condition monitoring include aircraft systems, oil and gas exploration and/or extraction systems (e.g., oil drilling rigs), industrial gas turbines, and many other complex systems.

Detection of anomalous activity within a system can provide many benefits, including, for example, quickly identifying components which need maintenance to return the system to proper operation, preventing downstream system failures, reducing costs associated with system down-time, etc. More generally, condition monitoring can enable a system operator to better manage system assets and components.

However, for many systems there are a large number of complex and different components for which condition monitoring represents a significant challenge. As one example, an oil drilling rig can include one or more blowout preventers (BOPs), which can be used, for example, to seal, control, and/or monitor oil and/or gas wells to prevent blowouts. In some instances, BOPs can be submerged under water or otherwise located in difficult to observe locations. Each BOP can typically include a number of different components (e.g., rams, annulars, etc.). Likewise, each BOP can typically operate to perform a number of different tasks or events. Thus, condition monitoring as various BOP components operate to perform various events represents a significant challenge, particularly for submerged or other difficult-to-observe BOPs.

As another example, an aviation system such as, for example, an aircraft engine also typically includes a large number of components that operate to perform different operations or events over time. Vast quantities of data can be collected from various sensors or other aircraft feedback mechanisms that describes operational conditions of the aircraft. For example, full flight data can be collected from commercial aircraft engines and analyzed to attempt to ensure proper aircraft operation. However, interpretation and synthesis of this vast amount of data can be a cumbersome, tedious, and error-prone problem.

Thus, enhanced systems and methods for complex system condition monitoring are desired.

### BRIEF DESCRIPTION OF THE INVENTION

Aspects and advantages of embodiments of the present disclosure will be set forth in part in the following description, or may be learned from the description, or may be learned through practice of the embodiments.

One example aspect of the present disclosure is directed to a condition monitoring system to monitor conditions at an oil and gas exploration or extraction system that includes one or more blowout preventers. The condition monitoring system includes one or more hydrophones that receive acoustic signals caused by operation of the one or more blowout preventers and generate a set of acoustic data indicative of operational conditions at the one or more blowout preventers based on the acoustic signals. The condition monitoring system includes a verification and anomaly detection component implemented by one or more processors. The verification and anomaly detection component uses a Mixture of Hidden Markov Models to at least one of: verify the operation of the one or more blowout preventers based on the acoustic data; and determine that an anomaly has occurred at the one or more blowout preventers based on the acoustic data.

Another example aspect of the present disclosure is directed to a computer-implemented method to perform condition monitoring for a system. The method includes obtaining, by one or more computing devices, a set of system data indicative of operational conditions at one or more components of the system. The method includes inputting, by the one or more computing devices, at least a portion of the set of system data into a Mixture of Hidden Markov Models. The method includes receiving, by the one or more computing devices, at least one classification and at least one fitness score as an output of the Mixture of Hidden Markov Models. The method includes determining, by the one or more computing devices based at least in part on the at least one classification and the at least one fitness score, an operational status of the one or more components of the system. The operational status is indicative of whether an anomaly has occurred at the one or more components of the system.

Another example aspect of the present disclosure is directed to a computer-implemented method for providing verification and anomaly detection. The method includes receiving, by one or more computing devices, a set of system data. The method includes extracting, by the one or more computing devices, one or more features from the set of system data. The method includes determining, by the one or more computing devices, one or more of a class prediction and a fitness score for the set of system data using a Mixture of Hidden Markov Models. The method includes determining, by the one or computing devices, that an anomaly has occurred based on the one or more of the class prediction and the fitness score.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1A depicts a block diagram of an example system to monitor operational conditions at an oil and gas exploration and/or extraction system according to example embodiments of the present disclosure;

FIG. 1B depicts an example workflow diagram of an example condition monitoring system according to example embodiments of the present disclosure;

FIG. 2 depicts an block diagram of an example condition monitoring system according to example embodiments of the present disclosure;

FIG. 3 depicts a flow chart diagram of an example method to perform condition monitoring according to example embodiments of the present disclosure;

FIG. 4 depicts a block diagram of an example networked environment according to example embodiments of the present disclosure; and

FIG. 5 depicts a block diagram of an example computing system or operating environment according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods which use a Mixture of Hidden Markov Models for condition monitoring. In particular, aspects of the present disclosure are directed to creation of a probabilistic Mixture of Hidden Markov Models (MoHMM) from a given data set collected from a system to be monitored. Further aspects of the present disclosure are directed to use of the MoHMM to perform condition monitoring for the system.

More particularly, a data set can be collected that is indicative of operational conditions at one or more components of the system. For example, the data set can include data from various types of sensors, data collection devices, or other feedback devices that monitor conditions at the one or more components or for the system as a whole. A plurality of features can be extracted from the data set. The data set can be fully or partially labelled. For example, labelling of data can be performed manually by human experts and/or according to known ground truth information during data collection. The data set can be used to train the MoHMM in a process generally known as training.

Once trained, the resulting MoHMM can be used for verification, classification, and/or anomaly detection. In particular, new, unlabeled data collected from the same system can be input into the MoHMM. In response to the new input data, the MoHMM can output at least one class prediction and/or at least one fitness score in a process generally known as prediction. In some implementations, features are extracted from the new data prior to input into the MoHMM.

In some implementations, the class prediction or classification can identify a particular event, action, or operation that the input data most closely resembles (e.g., matches features from training data that corresponds to such event or operation). Further, in some implementations, the fitness score can indicate a confidence in the class prediction or can be some other metric that indicates to what degree the input data resembles the event or operation identified by the class prediction.

The at least one class prediction and/or fitness score output by the MoHMM can be used to verify proper operation of the portion of the system being monitored (e.g., the portion from which or concerning which the data was collected). As one example, in some implementations, the MoHMM can output a single classification and/or fitness score which simply indicates whether the input data is classified as indicative of normal system operation or classified as indicative of anomalous system operation. For example, in some implementations, a single fitness score output by the MoHMM can be compared to a threshold value. A fitness score greater the threshold value can indicate that the system is properly operating, while a fitness score less than the threshold value can indicate that the system is not properly operating (e.g., an anomaly has occurred). In some implementations, the particular threshold value used can depend upon the class prediction provided by the MoHMM.

In other implementations, the MoHMM can output multiple class predictions and/or fitness scores. As one example, in some implementations, each Hidden Markov Model (HMM) included in the MoHMM can output a class prediction and corresponding fitness score for the set of input data. The class prediction that has the largest corresponding fitness score can be selected and used as the prediction provided by the MoHMM as a whole. Thus, the output of the MoHMM can be the most confident prediction provided by any of the HMMs included in the MoHMM.

As another example, in some implementations, the multiple classifications/scores output by the MoHMM can respectively identify multiple potential events to which the input data corresponds over time. In particular, the multiple classifications/scores can identify a sequence of events/operations over time.

More particularly, a monitored system can transition between events during operation. As an example, during a period of operation, an aircraft can have multiple events (e.g., a short-haul, a long-haul, etc.) and each event can consist of a number of its own events or sub-events (e.g., taxiing, take-off, ascent, etc.) that occur in a particular order. Likewise, the closing of an example annular BOP can consist of a number of events or sub-events with different characteristics, which again can occur in a particular order.

Thus, in some implementations, the MoHMM can output a plurality of classifications and a plurality of fitness scores respectively associated with the plurality of classifications. The plurality of classifications can identify a temporal sequence of different events experienced or performed by the system (as evidenced by the input data). The respective fitness score for each classification can indicate a confidence that the event identified by the corresponding classification was executed without an anomaly. As such, in some implementations, if all of the plurality of fitness scores for a series of classifications are respectively greater than a plurality of threshold values, then the entire sequence of identified events can be assumed to have occurred within normal operating parameter ranges. On the other hand, if one (or more) of the fitness scores for the series of classifications is less than its respective confidence score, then an anomaly can be detected with respect to the event identified by the classification to which such fitness score corresponds. In such way, aspects of the present disclosure can be used to provide condition monitoring, including anomaly detection, for complex systems which transition between multiple states or events over time.

Furthermore, in some implementations in which each Hidden Markov Model (HMM) included in the MoHMM outputs a class prediction and corresponding fitness score, the above described temporal sequence of different events predicted by the MoHMM can be identified by selecting, for any particular temporal segment or portion of input data, the class prediction that has the largest corresponding fitness score as the output of the MoHMM. Thus, the most confident class prediction for each segment of the input data can be used as the output of the MoHMM, thereby providing a temporal sequence of predictions which respectively identify the sequence of events.

In one example application of the present disclosure, aspects of the present disclosure can be applied to perform condition monitoring for one or more blowout preventers (BOPS) of an oil and gas exploration or extraction system. In one particular example, hydrophones can be used to collect acoustic data that describes acoustic signals resulting from operation of the BOPs. In some implementations, the acoustic data can be appropriately transformed and/or partially labelled by human experts. Subsequently, the transformed and/or labeled data can be used to train a MoHMM with a structure derived from knowledge about the data and the BOP system and events. The trained MoHMM can then be used for event prediction and anomaly detection based on new hydrophone data that has been transformed in the same way as the training data.

In another example application, aspects of the present disclosure can be applied to perform condition monitoring for one or more aviation systems, such as aircraft engines. For example, full-flight data can be input into a trained MoHMM to receive predictions (e.g., verification or anomaly detection) regarding the operational status of various aviation systems. As noted above, use of MoHMM in this fashion can be particularly advantageous for condition monitoring for systems which undergo a temporal sequence of events, such as taxiing, take-off, ascent, etc., as described above.

Furthermore, aspects of the present disclosure are based in part on fundamental probability theory and thus provide a clear framework that enables models to be altered or extended. For instance, aspects of the present disclosure enable incorporation of data from new sensors, or combination with other (probabilistic) models.

In addition, aspects of present disclosure offer a commercial advantage by providing a principled way to deal with the inherent uncertainty in models that, out of necessity, are built from noisy data. For example, aspects of the present disclosure allow the association of different costs with different kinds of event misclassifications, which can be combined with the probabilistic predictions of the model to derive decision strategies that are expected to be optimal over time.

Although example aspects of the present disclosure are discussed with reference to blowout prevention systems and/or aviation systems, the subject matter described herein can be used with or applied to other systems, vehicles, machines, industrial or mechanical assets, or components without deviating from the scope of the present disclosure.

With reference now to the FIGS., example aspects of the present disclosure will be discussed in further detail.

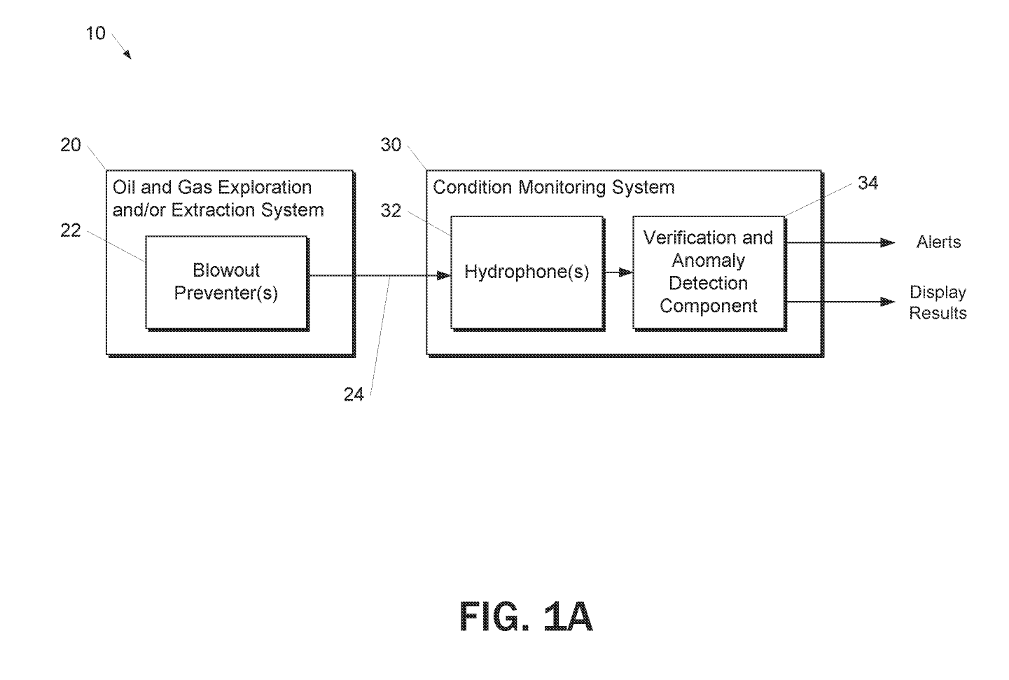

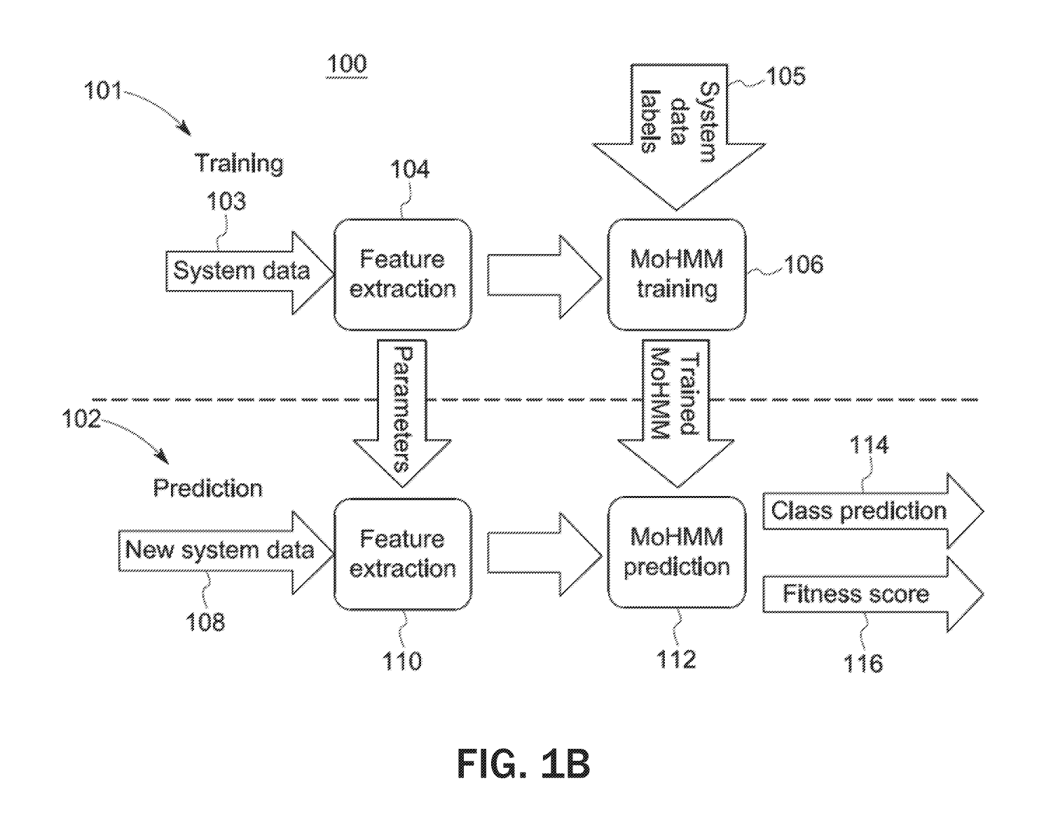

FIG. 1A depicts a block diagram of an example system 10 to monitor operational conditions at an oil and gas exploration and/or extraction system 20 according to example embodiments of the present disclosure. For example, the oil and gas exploration and/or extraction system 20 can be an oil drilling rig.

The oil and gas exploration and/or extraction system 20 can include one or more blowout preventers (BOPS) 22, which can be used, for example, to seal, control, and/or monitor oil and/or gas wells to prevent blowouts. In some instances, the BOPs 22 can be submerged under water or otherwise located in difficult to observe locations. Each BOP 22 can typically include a number of different components (e.g., rams, annulars, etc.). Likewise, each BOP 22 can typically operate to perform a number of different tasks or events.

Operation of the BOPs 22 can cause or otherwise result in acoustic signals 24. As used herein, acoustic signals 24 can include any signal that is mechanically propagated through a medium. As non-limiting examples, acoustic signals 24 can include a sound wave propagated through a fluid medium such as gas or water, vibrations propagated through a solid medium, and/or some combination thereof. Acoustic signals 24 can be humanly perceivable or non-humanly perceivable.

The system 10 includes a condition monitoring system 30 that monitors conditions at the oil and gas system 20. The condition monitoring system 30 can include one or more hydrophones 32 and a verification and anomaly detection component 34.

The hydrophones 32 can monitor subsea installations (e.g., BOPs 22), and deliver acoustic data regarding operations of components (e.g., rams, annulars, etc.). In particular, the hydrophones 32 can receive the acoustic signals 24 and transform the acoustic signals 32 in acoustic data (e.g., a digital electronic signal or an analog electronic signal). Data from the hydrophones 32 can be provided to the verification and anomaly detection component (VAD component) 34.

The VAD component 34 can detect and classify events occurring at the BOPs 22 based on application of a Mixture of Hidden Markov Models to the acoustic data. The VAD component 34 can output alerts and/or display results to a user. In particular, the VAD component 34 can provide indicators of normal system operation and/or anomaly detection.

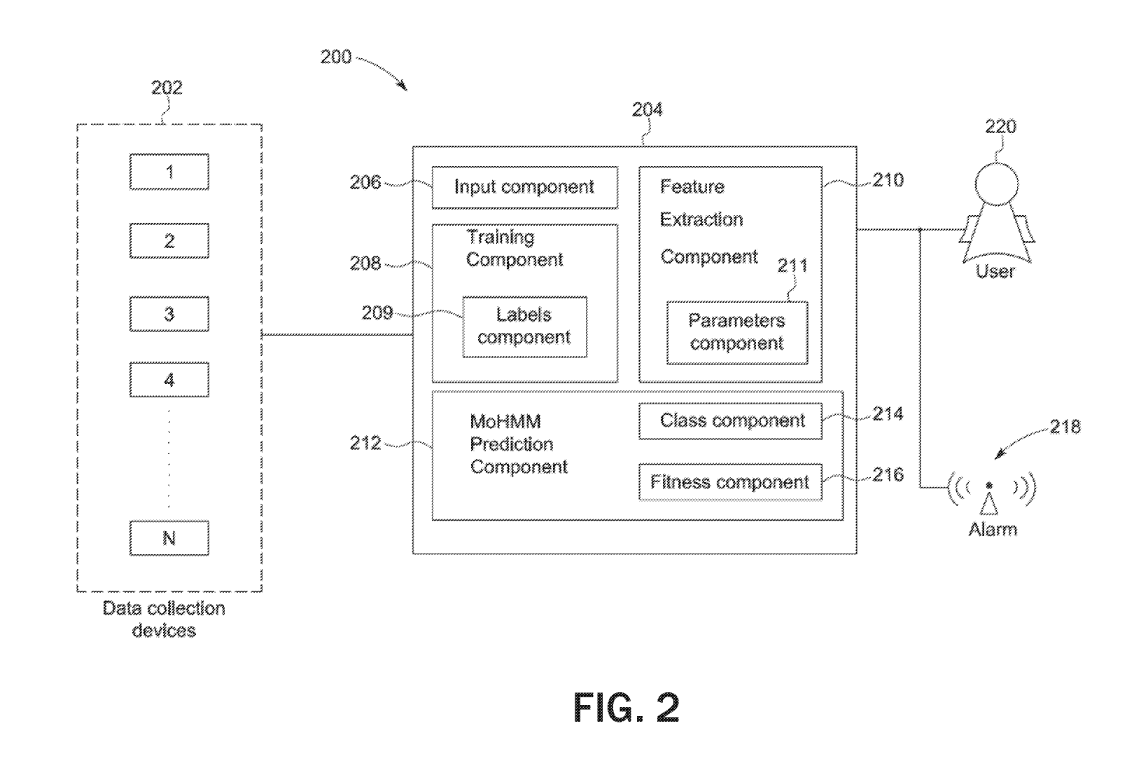

The VAD component 34 can be the same as or similar to the VAD component 204 that will be discussed in further detail with reference to FIG. 2. Although BOPs 22 are illustrated in FIG. 1A, the condition monitoring system 30 can operate to monitor conditions for other, different components of the oil and gas exploration and/or extraction system 20 in addition to or alternatively to the BOPs 22. Further, although hydrophones 32 are illustrated in FIG. 1A, other data collection devices can be used in addition or alterternatively to hydrophones 32.

FIG. 1B depicts an example workflow diagram of an example condition monitoring system 100 according to example embodiments of the present disclosure. The condition monitoring system 100 is illustrated as including a training portion 101 and a prediction portion 102.

The training portion 101 includes a set of system data 103 that is provided for feature extraction 104. The system data 103 can be obtained, acquired, or otherwise received from a set of data collection devices. For example, the data collection devices can include, but are not limited to, a set of sensors, one or more imagers, etc.

The feature extraction 104 can isolate, obtain, or otherwise extract one or more values of interest or features based on a set of feature extraction criteria, rules or parameters. The feature extraction parameters can be preset, learned or dynamically adjusted.

Extracted features can be provided to a Mixture of Hidden Markov Models (MoHMM) for training 106. Additionally, a set of system data labels 105 can be provided to facilitate the MoHMM training 106. For example, a first label in the set of labels 105 can identify an event or operation associated with a first extracted feature or with a first set of features belonging to a particular instance or example. One or more HMM included in the MoHMM can be trained to recognize the operation based on the first extracted feature and the first label. As examples, the MoHMM training 106 can perform a Baum-Welch technique (which may also be known as a Forward-Backward technique and/or an Expectation-Maximization algorithm) to train the HMMs.

The training 101 can be temporary or on-going. For example, the training 101 may only occur during setup or installation of the condition monitoring system 100. Additionally or alternatively, the training 101 may continue during standard operation (e.g., during prediction 102) of the condition monitoring system 100 to improve prediction 102.

The prediction portion 102 includes new system data 108. Similar to the system data 103 used in the training portion 101, the new system data 108 can be received from the same or an expanded set of data collection devices. The new system data 108 is provided for feature extraction 110. Feature extraction 110 can employ a set of parameters refined during the training portion 101 for feature extraction 104. The extracted features are provided to (e.g., input into) the MoHMM for prediction 112, wherein the MoHMM includes HMMs that have been trained during the training portion 101.

The prediction 112 can generate, produce, or otherwise output a class prediction 114 and/or a fitness score 116. The class prediction 114 and fitness score 116 can indicate or verify normal operation of a system associated with the new system data 108. Additionally or alternatively, the class prediction 114 and/or fitness score 116 can detect an anomaly in the operation of the associated system. For example, if an operation has a fitness score 116 not satisfying a predetermined threshold then it can indicate that the operation is an anomaly. As another example, if the MoHMM outputs a uncertain classification in which all possible classifications receive a low fitness score (indicating that they are similarly unlikely) then it can indicate that the operation is an anomaly.

In further implementations, the prediction 112 can output multiple class predictions 114 and/or fitness scores 116. In particular, in some implementations, the multiple class predictions 114 can respectively identify multiple potential events to which the new system data 108 corresponds. For example, the multiple classifications/scores 114/116 can identify a sequence of events/operations over time.

Thus, in some implementations, the plurality of classifications 114 can identify a temporal sequence of different events experienced or performed by the system (as evidenced by the new system data 108). The respective fitness score 116 for each classification 114 can indicate a confidence that the event identified by the corresponding classification 114 was executed without an anomaly. As such, in some implementations, if all of the plurality of fitness scores 116 are respectively greater than a plurality of threshold values, then the entire sequence of identified events can be assumed to have occurred within normal operating parameter ranges. On the other hand, if one (or more) of the fitness scores 116 is less than its respective confidence score, then an anomaly can be detected with respect to the event identified by the classification 114 to which such fitness score corresponds. In such way, the prediction portion 102 can be used to provide condition monitoring, including anomaly detection, for complex systems which transition between multiple states or events over time.

The training portion 101 (including the feature extraction 104 and the MoHMM training 106) can be performed or otherwise implemented by one or more computing devices, which include one or more processors executing instructions stored in a non-transitory computer readable medium. For example, in some implementations, the feature extraction 104 and the MoHMM training 106 correspond to or otherwise include computer logic utilized to provide desired functionality. Thus, each of the feature extraction 104 and the MoHMM training 106 can be implemented in hardware, application specific circuits, firmware and/or software controlling a general purpose processor. In one embodiment, each of the feature extraction 104 and the MoHMM training 106 correspond to program code files stored on a storage device, loaded into memory and executed by a processor or can be provided from computer program products, for example computer executable instructions, that are stored in a tangible computer-readable storage medium such as RAM, hard disk or optical or magnetic media.

Likewise, the prediction portion 102 (including the feature extraction 110 and the MoHMM prediction 112) can be performed or otherwise implemented by one or more computing devices, which include one or more processors executing instructions stored in a non-transitory computer readable medium. The one or more computing devices that implement the prediction portion 102 can be the same as, different than, or overlapping with respect to the one or more computing devices that perform the training portion 101. For example, in some implementations, the feature extraction 110 and the MoHMM prediction 112 correspond to or otherwise include computer logic utilized to provide desired functionality. Thus, each of the feature extraction 110 and the MoHMM prediction 112 can be implemented in hardware, application specific circuits, firmware and/or software controlling a general purpose processor. In one embodiment, each of the feature extraction 110 and the MoHMM prediction 112 correspond to program code files stored on a storage device, loaded into memory and executed by a processor or can be provided from computer program products, for example computer executable instructions, that are stored in a tangible computer-readable storage medium such as RAM, hard disk or optical or magnetic media.

Turning now to FIG. 2, illustrated is an example condition monitoring system 200 in accordance with various aspects described herein. The condition monitoring system 200 can include a set of data collection devices 202, and a verification and anomaly detection component 204.

The set of collection devices 202 can include N data collection devices, where N is an integer. The collection devices 202 can include, but are not limited to, a set of sensors. For example, the data collection devices 202 can include passive acoustic systems that utilize hydrophones. The hydrophones can monitor subsea installations (e.g., blowout preventers (BOPs)), and deliver acoustic data regarding operations of components (e.g., rams, annulars, etc.). Data from the data collection devices 202 can be provided to the verification and anomaly detection component (VAD component) 204.

The VAD component 204 includes an input component 206, a training component 208, a feature extraction component 210, and a MoHMM prediction component 212. The VAD component 204 can also include one or more processors (not illustrated) and a memory (not illustrated). The one or more processors can be any suitable processing device (e.g., a processor core, a microprocessor, an ASIC, a FPGA, a controller, a microcontroller, etc.) and can be one processor or a plurality of processors that are operatively connected. The memory can include one or more non-transitory computer-readable mediums, such as RAM, ROM, EEPROM, EPROM, flash memory devices, magnetic disks, etc., and combinations thereof. The memory can store instructions which are executed by the processor to perform operations.

Referring again to FIG. 2, the input component 206 obtains, acquires, or otherwise receives data from the data collection devices 202. As discussed, the data can include, for example, acoustic data related to the operation of components of BOPs. Additionally, the data can include training data and/or actual operational data. Moreover, the input component 206 can provide or implement any necessary or desired preprocessing.

The training component 208 can train HMMs based at least in part on a set of training data. The training component 208 can further include a labels component 209. The labels component 209 can receive or maintain labels that facilitate training the HMMS. For example, a set of labels can be provided by a technician to identify an operation included in data for training. Based on the labels and data, a set of HMMs can be trained to recognize, identify or otherwise classify an operation.

The feature extraction component 210 can isolate, obtain, or otherwise extract one or more values of interest or features from the data. The feature extraction component 210 can include a parameters component 211 that determines receives or maintains a set of feature extraction criteria, rules or parameters. For example, the parameters can be input or entered in the parameters component 211 by a user, expert or technician. Additionally or alternatively, the parameters can be learned or dynamically selected by the parameters component 211. The feature extraction component 210 can utilize the criteria, rules or parameters to identify and extract the features from the data.

The MoHMM Prediction Component 212 applies, exploits, or otherwise utilizes trained HMMs (e.g., via training component 208) for verification and anomaly detection of operations in extracted features. The MoHMM component can include a class component 214 and a fitness component 216. Returning to a previous example, a MINI included in the MoHMM can identify and verify an extracted feature as an annular opening of a BOP. Additionally or alternatively, if none of the HMMs can reliably or satisfactorily identify an operation associated with an extracted feature (e.g., all classes receive a similarly low score), then the MoHMM component 212 can determine that the operation is an anomaly. The class component 214 can indicate if an operation belongs to a known class or otherwise provide a class prediction, and the fitness component 216 determines and provides a score regarding the fitness of a candidate HMM identifying the operation. For example, the fitness component 216 can provide a score as a value indicating a likelihood that a HMM has correctly identified the operation. If the score does not satisfy a predetermined threshold, then the MoHMM prediction component 212 may determine that the operation is an anomaly.

The results from the MoHMM prediction component 212 can be provided to a user 220, and/or used to trigger an alarm 218. For example, where an operation associated with a BOP is determined to be an anomaly, the alarm 218 can be triggered to warn, alert, or otherwise notify personnel. Additionally or alternatively, the results can be provided to the user 220, for example, via a computer interface.

The VAD component 204 (including the input component 206, the training component 208, the labels component 209, the feature extraction component 210, the parameters component 211, the MoHMM prediction component 212, the class component 214, and the fitness component 216) can correspond to or otherwise include computer logic utilized to provide desired functionality. Thus, each of such components can be implemented in hardware, application specific circuits, firmware and/or software controlling a general purpose processor. In one embodiment, each of such components corresponds to program code files stored on a storage device, loaded into memory and executed by a processor or can be provided from computer program products, for example computer executable instructions, that are stored in a tangible computer-readable storage medium such as RAM, hard disk or optical or magnetic media.

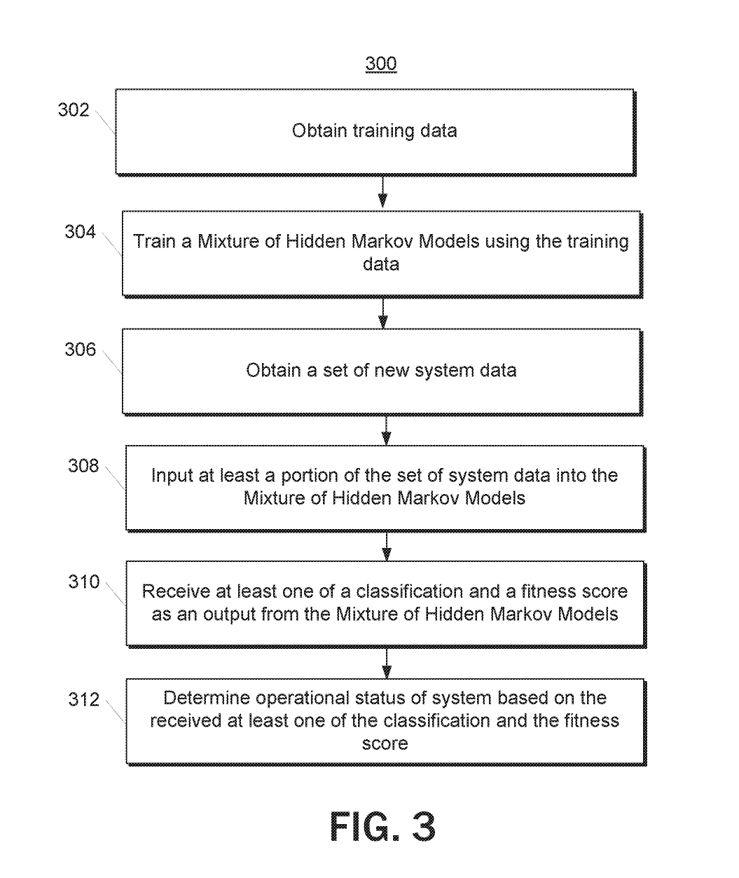

FIG. 3 depicts a flow chart diagram of an example method 300 to perform condition monitoring according to example embodiments of the present disclosure.

At 302, the condition monitoring system obtains a set of training data from the system to be monitored. For example, the training data set can include data from various types of sensors or other feedback devices which monitor conditions at the one or more components or for the system as a whole.

In some implementations, a plurality of features can be extracted from the data set at 302. For example, one or more values of interest or other features can be isolated, obtained, or otherwise extracted based on a set of feature extraction criteria, rules, or parameters. The feature extraction parameters can be preset, learned or dynamically adjusted.

In some implementations, the training data set can also be fully or partially labelled at 302. For example, labelling of data can be performed manually by human experts and/or according to known ground truth information during data collection.

At 304, the condition monitoring system trains a Mixture of Hidden Markov Models (MoHMM) using the training data. As examples, the MoHMM training 106 can perform a Baum-Welch technique (which may also be known as a Forward-Backward technique and/or an Expectation-Maximization algorithm) to train the HMMs.

At 306, the condition monitoring system obtains a set of new system data. For example, similar to the training data obtained at 302, the new system data obtained at 306 can be received from the same or an expanded set of data collection devices. In some implementations, the new system data can be provided for feature extraction at 306. Feature extraction can employ a set of parameters refined during training at 304.

At 308, the condition monitoring system inputs at least a portion of the set of system data into the MoHMM. At 310, the condition monitoring system receives at least one of a classification and/or at least one fitness score as an output from the MoHMM. In some implementations, the classification can identify a particular event, action, or operation that the input set of system data most closely resembles. Further, in some implementations, the fitness score can indicate a confidence in the classification or other metric that indicates to what degree the input set of system data resembles the event or operation identified by the classification.

At 312, the condition monitoring system determines an operational status of the system to be monitored based at least in part on the received at least one of the classification and the fitness score. As one example, in some implementations, the MoHMM can output at 310 a single classification and/or fitness score which simply indicates whether the input data is classified as indicative of normal system operation or classified as indicative of anomalous system operation. For example, in some implementations, to determine the operational status at 312, the condition monitoring system can compare the single fitness score output by the MoHMM to a threshold value. A fitness score greater the threshold value can indicate that the system is properly operating, while a fitness score less than the threshold value can indicate that the system is not properly operating (e.g., an anomaly has occurred). In some implementations, the particular threshold value used can depend upon the class prediction provided by the MoHMM.

In other implementations, the MoHMM can output multiple class predictions and/or fitness scores at 310. As one example, in some implementations, each Hidden Markov Model (HMM) included in the MoHMM can output a class prediction and corresponding fitness score for the set of input data. The class prediction that has the largest corresponding fitness score can be selected at 312 and used to determine the operational status of the system (e.g., by comparison to a threshold value). Thus, the output of the MoHMM can be the most confident prediction provided by any of the HMMs included in the MoHMM.

As another example, in some implementations, the multiple classifications/scores output by the MoHMM can respectively identify multiple potential events to which the input data corresponds over time. In particular, the multiple classifications/scores can identify a sequence of events/operations over time.

Thus, in some implementations, at 310, the MoHMM can output a plurality of classifications and a plurality of fitness scores respectively associated with the plurality of classifications. The plurality of classifications can identify a temporal sequence of different events experienced or performed by the system (as evidenced by the input data). The respective fitness score for each classification can indicate a confidence that the event identified by the corresponding classification was executed without an anomaly.

As such, in some implementations, to determine the operational status of the system at 312, the condition monitoring system can respectively compare the plurality of fitness scores to a plurality of threshold values. If all of the plurality of fitness scores for a series of classifications are respectively greater than the plurality of threshold values, then the entire sequence of identified events can be assumed to have occurred within normal operating parameter ranges. On the other hand, if one (or more) of the fitness scores for the series of classifications is less than its respective confidence score, then an anomaly can be detected with respect to the event identified by the classification to which such fitness score corresponds. In such way, aspects of the present disclosure can be used to provide condition monitoring, including anomaly detection, for complex systems which transition between multiple states or events over time.

Furthermore, in some implementations in which each Hidden Markov Model (HMM) included in the MoHMM outputs a class prediction and corresponding fitness score at 310, the above described temporal sequence of different events predicted by the MoHMM can be identified at 312 by selecting, for any particular temporal segment or portion of input data, the class prediction that has the largest corresponding fitness score as the output of the MoHMM. Thus, the most confident class prediction for each segment of the input data can be used as the output of the MoHMM, thereby providing a temporal sequence of predictions which respectively identify the sequence of events. The temporal sequence of predictions can be analyzed for anomaly detection as described above (e.g., comparing the fitness scores from the selected predictions to respective threshold values).

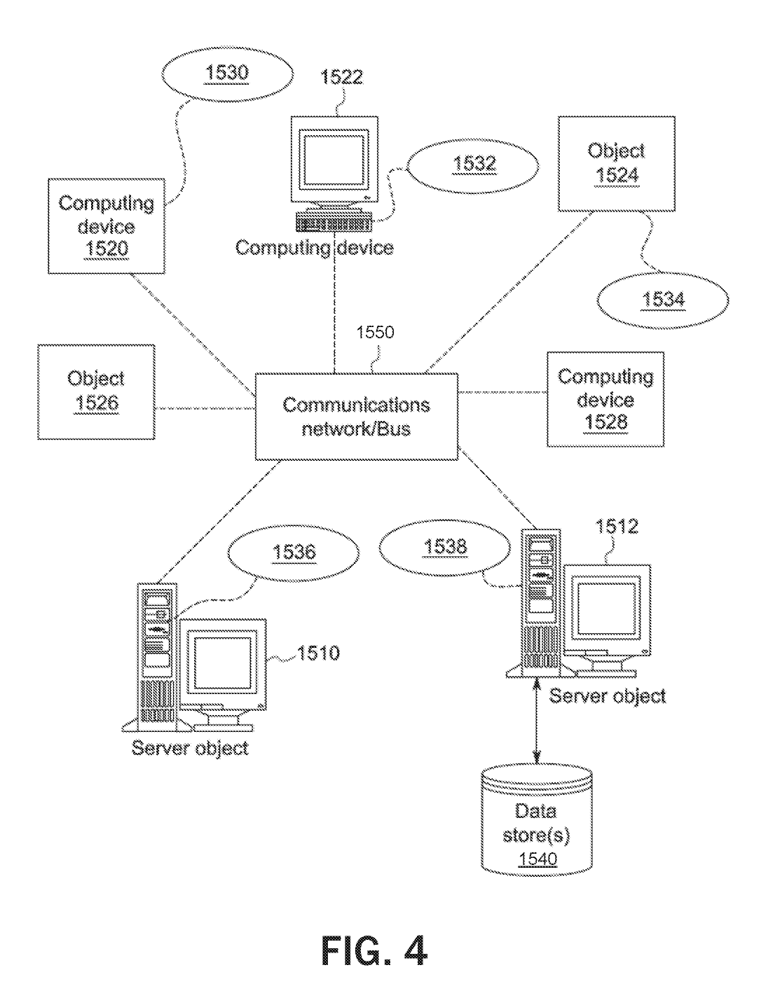

FIG. 4 provides a schematic diagram of an exemplary networked or distributed computing environment. The distributed computing environment comprises computing objects 1510, 1512, etc. and computing objects or devices 1520, 1522, 1524, 1526, 1528, etc., which may include programs, methods, data stores, programmable logic, etc., as represented by applications 1530, 1532, 1534, 1536, 1538 and data store(s) 1540. It can be appreciated that computing objects 1510, 1512, etc. and computing objects or devices 1520, 1522, 1524, 1526, 1528, etc. may comprise different devices, such as personal digital assistants (PDAs), audio/video devices, mobile phones, MP3 players, personal computers, laptops, etc.

Each computing object 1510, 1512, etc. and computing objects or devices 1520, 1522, 1524, 1526, 1528, etc. can communicate with one or more other computing objects 1510, 1512, etc. and computing objects or devices 1520, 1522, 1524, 1526, 1528, etc. by way of the communications network 1550, either directly or indirectly. Even though illustrated as a single element in FIG. 4, communications network 1550 may comprise other computing objects and computing devices that provide services to the system of FIG. 4, and/or may represent multiple interconnected networks, which are not shown. Each computing object 1510, 1512, etc. or computing object or devices 1520, 1522, 1524, 1526, 1528, etc. can also contain an application, such as applications 1530, 1532, 1534, 1536, 1538, that might make use of an API, or other object, software, firmware and/or hardware, suitable for communication with or implementation of the techniques for dynamic code generation and memory management for COM objects provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for dynamic code generation and memory management for COM objects as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 4, as a non-limiting example, computing objects or devices 1520, 1522, 1524, 1526, 1528, etc. can be thought of as clients and computing objects 1510, 1512, etc. can be thought of as servers where computing objects 1510, 1512, etc., acting as servers provide data services, such as receiving data from client computing objects or devices 1520, 1522, 1524, 1526, 1528, etc., storing of data, processing of data, transmitting data to client computing objects or devices 1520, 1522, 1524, 1526, 1528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1550 or bus is the Internet, for example, the computing objects 1510, 1512, etc. can be Web servers with which other computing objects or devices 1520, 1522, 1524, 1526, 1528, etc. communicate via any of a number of known protocols, such as the hypertext transfer protocol (HTTP). Computing objects 1510, 1512, etc. acting as servers may also serve as clients, e.g., computing objects or devices 1520, 1522, 1524, 1526, 1528, etc., as may be characteristic of a distributed computing environment.

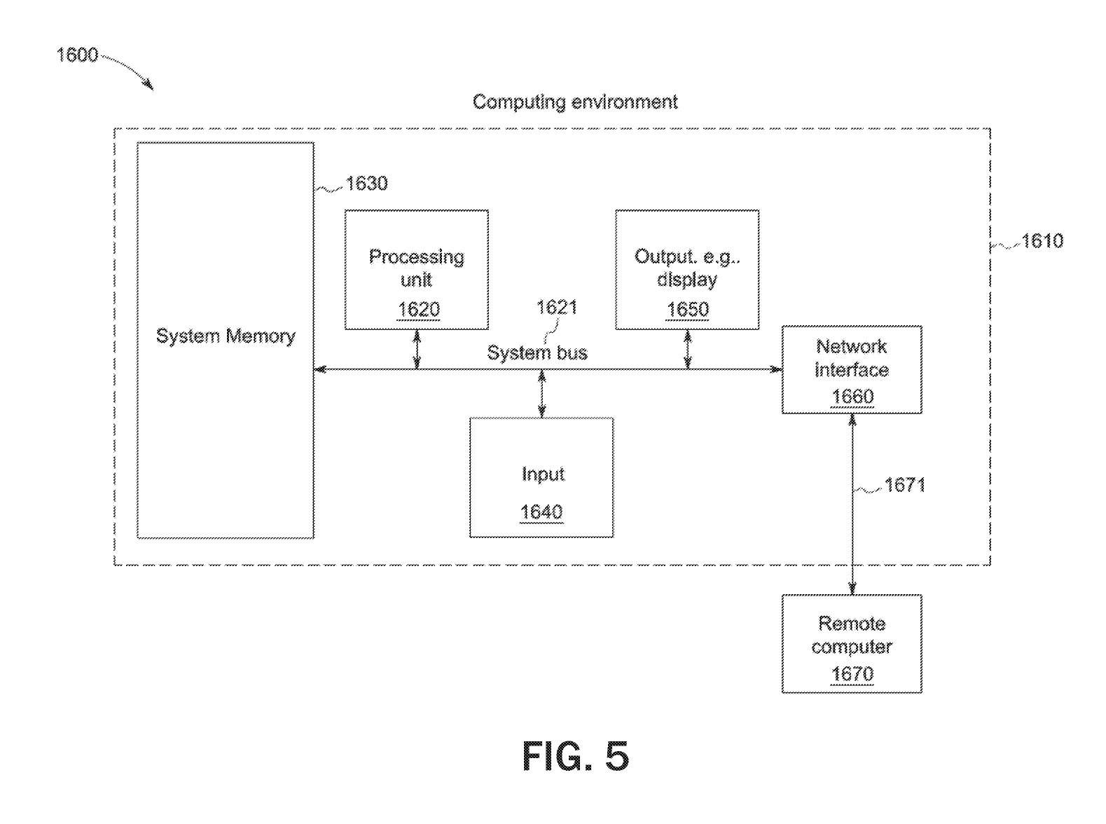

Advantageously, the techniques described herein can be applied to any device or system to perform condition monitoring as described herein. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 5 illustrates an example of a suitable computing system environment 1600 in which one or aspects of the embodiments described herein can be implemented, although as made clear above, the computing system environment 1600 is only one example of a suitable computing environment and is not intended to suggest any limitation as to scope of use or functionality. Neither should the computing system environment 1600 be interpreted as having any dependency or requirement relating to any one or combination of components illustrated in the exemplary computing system environment 1600.

With reference to FIG. 5, an exemplary remote device for implementing one or more embodiments includes a general purpose computing device in the form of a computer 1610. Components of computer 1610 may include, but are not limited to, a processing unit 1620, a system memory 1630, and a system bus 1621 that couples various system components including the system memory to the processing unit 1620.

Computer 1610 typically includes a variety of computer readable media and can be any available media that can be accessed by computer 1610. The system memory 1630 may include computer storage media in the form of volatile and/or nonvolatile memory such as read only memory (ROM) and/or random access memory (RAM). By way of example, and not limitation, system memory 1630 may also include an operating system, application programs, other program modules, and program data. According to a further example, computer 1610 can also include a variety of other media (not shown), which can include, without limitation, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 1610 through input devices 1640. A monitor or other type of display device is also connected to the system bus 1621 via an interface, such as output interface 1650. In addition to a monitor, computers can also include other peripheral output devices such as speakers and a printer, which may be connected through output interface 1650.

The computer 1610 may operate in a networked or distributed environment using logical connections, such as network interfaces 1660, to one or more other remote computers, such as remote computer 1670. The remote computer 1670 may be a personal computer, a server, a router, a network PC, a peer device or other common network node, or any other remote media consumption or transmission device, and may include any or all of the elements described above relative to the computer 1610. The logical connections depicted in FIG. 5 include a network 1671, such local area network (LAN) or a wide area network (WAN), but may also include other networks/buses. Such networking environments are commonplace in homes, offices, enterprise-wide computer networks, intranets and the Internet.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims. Accordingly, the invention is not to be limited to any single embodiment or implementation, but rather can be construed in breadth, spirit and scope in accordance with the appended claims.

What is claimed is:

1. A condition monitoring system to monitor conditions at an oil and gas exploration or extraction system that includes one or more blowout preventers, the condition monitoring system comprising:
one or more hydrophones that:
receive acoustic signals caused by operation of the one or more blowout preventers; and
generate a set of acoustic data indicative of operational conditions at the one or more blowout preventers based on the acoustic signals; and
a verification and anomaly detection component implemented by one or more processors, wherein the verification and anomaly detection component uses a Mixture of Hidden Markov Models to at least one of:
verify the operation of the one or more blowout preventers based on the acoustic data; and
determine that an anomaly has occurred at the one or more blowout preventers based on the acoustic data.

2. The condition monitoring system of claim 1, further comprising:
a feature extraction component implemented by one or more processors, wherein the feature extraction component extracts one or more features from the acoustic data based on a set of parameters.

3. The condition monitoring system of claim 1, further comprising:
a training component implemented by one or more processors, wherein the training component trains a plurality of Hidden Markov Models for inclusion in the Mixture of Hidden Markov Models.

4. The condition monitoring system of claim 1, wherein the verification and anomaly detection component triggers an alarm in response to a determination that an anomaly has occurred.

5. A computer-implemented method to perform condition monitoring for a system, the method comprising:
obtaining, by one or more computing devices, a set of system data indicative of operational conditions at one or more components of the system;
inputting, by the one or more computing devices, at least a portion of the set of system data into a Mixture of Hidden Markov Models;
receiving, by the one or more computing devices, at least one classification and at least one fitness score as an output of the Mixture of Hidden Markov Models;
determining, by the one or more computing devices based at least in part on the at least one classification and the at least one fitness score, an operational status of the one or more components of the system, the operational status indicative of whether an anomaly has occurred at the one or more components of the system.

6. The computer-implemented method of claim 5, wherein determining, by the one or more computing devices based at least in part on the at least one classification and the at least one fitness score, the operational status of the one or more components of the system comprises:
comparing, by the one or more computing devices, the fitness score to a threshold value;
in response to a determination that the fitness score is greater than the threshold value, determining, by the one or more computing devices, that an event identified by the classification occurred at the system without an anomaly; and
in response to a determination that the fitness score is less than the threshold value, determining, by the one or more computing devices, that an anomaly has occurred at the one or more components of the system.

7. The computer-implemented method of claim 5, wherein obtaining, by the one or more computing devices, the set of system data comprises obtaining, by the one or more computing devices, a set of acoustic data indicative of operational conditions at one or more blowout preventers of an oil drilling system, the set of acoustic data collected by one or more hydrophones.

8. The computer-implemented method of claim 5, wherein obtaining, by the one or more computing devices, the set of system data comprises obtaining, by the one or more computing devices, a set of full flight aviation data indicative of operational conditions at one or more components of an aircraft engine.

9. The computer-implemented method of claim 5, wherein obtaining, by the one or more computing devices, the set of system data comprises obtaining, by the one or more computing devices, the set of system data collected while the system transitions between a plurality of different events over time.

10. The computer-implemented method of claim 9, wherein receiving, by the one or more computing devices, the at least one classification and the at least one fitness score comprises receiving, by the one or more computing devices, a plurality of classifications and a plurality of fitness scores respectively associated with the plurality of classifications as an output of the Mixture of Hidden Markov Models, wherein each of the plurality of classifications identifies a respective one of the plurality of different events, and wherein the fitness score for each classification indicates a confidence that the event identified by the corresponding classification was executed without an anomaly.

11. The computer-implemented method of claim 9, further comprising:
obtaining, by the one or more computing devices, a plurality of threshold values respectively for the plurality of classifications;
wherein determining, by the one or more computing devices, the operational status of the one or more components of the system comprises:
comparing, by the one or more computing devices, each of the plurality of fitness scores to the respective threshold value for the classification to which such fitness score corresponds;
in response to a determination that all of the fitness score are greater than their respective threshold values, determining, by the one or more computing devices, that the events identified by the classifications occurred at the system without an anomaly; and
in response to a determination that one or more of the fitness score are less than their respective threshold values, determining, by the one or more computing devices, that an anomaly has occurred at the one or more components of the system during the one or more events respectively identified by the one or more classifications to which such one or more fitness scores correspond.

12. The computer-implemented method of claim 5, further comprising, prior to inputting, by the one or more computing devices, at least the portion of the set of system data into the Mixture of Hidden Markov Models:
training, by the one or more computing devices, the Mixture of Hidden Markov Models on a set of training data, wherein the set of training data is labeled.

13. A computer-implemented method for providing verification and anomaly detection, the method comprising:
receiving, by one or more computing devices, a set of system data;
extracting, by the one or more computing devices, one or more features from the set of system data;
determining, by the one or more computing devices, one or more of a class prediction and a fitness score for the set of system data using a Mixture of Hidden Markov Models; and
determining, by the one or computing devices, that an anomaly has occurred based on the one or more of the class prediction and the fitness score.

14. The method of claim 13, further comprising:
triggering, by the one or more computing devices, an alarm based on the anomaly.

15. The method of claim 13, wherein receiving, by the one or more computing devices, the set of system data comprises receiving, by the one or more computing devices, the set of system data from one or more sensors.

16. The method of claim 15, wherein receiving, by the one or more computing devices, the set of system data from one or more sensors comprises receiving, by the one or more computing devices, the set of system data from one or more hydrophones.

17. The method of claim 16, wherein receiving, by the one or more computing devices, the set of system data from one or more hydrophones comprises receiving, by the one or more computing devices, a set of acoustic data from one or more hydrophones.

18. The method of claim 17, wherein receiving, by the one or more computing devices, the set of acoustic data from one or more hydrophones comprises receiving, by the one or more computing devices, the set of acoustic data that is associated with operation of a blowout preventer.

19. The method of claim 13, further comprising:
providing, by the one or more computing devices, the one or more of the class prediction and the fitness score to a user.

20. The method of claim 13, wherein extracting, by the one or more computing devices, the one or more features from the set of system data comprises extracting, by the one or more computing devices, the features based on a set of feature extraction parameters.
